(19) United States
(12) Patent Application Publication
(10) Pub. No.: US 2016/0122611 A1
(43) Pub. Date: May 5, 2016

(54) SILICONE RUBBER COMPOSITION FOR THERMALLY CONDUCTIVE SILICONE-RUBBER DEVELOPMENT MEMBER, AND THERMALLY CONDUCTIVE SILICONE-RUBBER DEVELOPMENT MEMBER

(71) Applicant: SHIN-ETSU CHEMICAL CO., LTD., Tokyo (JP)

(72) Inventors: Shinichiro YOSHIDA, Annaka-shi (JP); Satao HIRABAYASHI, Annaka-shi (JP)

(73) Assignee: SHIN-ETSU CHEMICAL CO., LTD., Tokyo (JP)

(21) Appl. No.: 14/894,265

(22) PCT Filed: May 20, 2014
(86) PCT No.: PCT/JP2014/063277

§ 371 Date: Nov. 25, 2015

(30) Foreign Application Priority Data
Jun. 19, 2013 (JP) 2013-128339

(51) Int. Cl. C09K 5/14; G03G 15/08

(52) U.S. Cl. CPC C09K 5/14; G03G 15/0808

(57) ABSTRACT

A silicone rubber composition for thermally conductive silicone-rubber development members which comprises (A) 100 parts by mass of an organopolysiloxane having, in the molecule, at least two alkenyl groups each bonded to a silicon atom, (B) 40-400 parts by mass of a thermally conductive powder that has an average primary-particle diameter of 30 μm or smaller and a thermal conductivity of 10 W/m·K or greater, (C) 1-50 parts by mass of carbon black, and (D) a hardener in an amount capable of curing the component (A) and which gives a cured silicone rubber having a thermal conductivity of 0.28 W/m·K or greater. With the silicone rubber composition for thermally conductive silicone-rubber development members, it is possible to provide a thermally conductive silicone-rubber development member (roll, belt, etc.) which comprises a silicone rubber layer formed by curing the silicone rubber composition and which is excellent in terms of image characteristics and has the feature of high thermal conductivity.

### TECHNICAL FIELD

This invention relates to a silicone rubber composition for a thermally conductive silicone rubber development member having excellent image properties, and to a thermally conductive silicone rubber development member such as a silicone development roll or a silicone development belt having a silicone rubber layer obtained by curing such a composition. More specifically, the invention relates to an addition-curable or organic peroxide-curable silicone rubber composition for a thermally conductive silicone rubber development member, and to a thermally conductive silicone rubber development member such as a silicone development roll or a silicone development belt having a silicone rubber layer obtained by curing such a composition, wherein the silicone rubber layer obtained by curing this silicone rubber composition to which has been added a silicon metal powder, particularly a silicon metal powder and carbon black, efficiently lowers the surface temperature of the development roll or development belt and is thereby able to reduce damage to the toner.

### BACKGROUND ART

Owing to their excellent electrical insulating properties, heat resistance, weatherability and fire retardance, silicone rubbers are used in a variety of fields, including electrical and electronic applications such as household appliances and computers, transportation equipment components, office automation equipment and construction applications. In recent years, by virtue of their weather and heat resistance, silicone rubbers have come to be used in particular as a coating material on computer heat sinks and on fixing roll members such as development rolls, heater rolls and pressure rolls in copiers and electrophotographic printers. Most recently, with higher copier speeds and the widespread use of color copiers, there exists a desire with regard also to development rolls for performance enhancements critical to higher copier speeds.

Copiers and electrophotographic printers use colored particles referred to as “toners.” The single-component toners predominantly in use today are made using polyester resins and styrene-acrylic resin. These toners are required to be quick-melting because of the higher printing speeds. In addition, from the standpoint of reducing energy consumption by the machine itself, the trend in toner design melting points is toward lower temperatures.

At the same time, to enable the development roll to handle higher printing speeds, lower hardness and increased surface smoothness have hitherto been required of the rubber. However, with the lower toner melting points in recent years, the influence on the toner of frictional heat generated on the development roll has become larger, making low-temperature control of the development roll surface important.

Hence, there exists a desire for high heat dissipation and high thermal conductivity in silicone rubbers, in addition to which there is also a desire for low compression set. Yet, silicone rubbers do not themselves have a high thermal conductivity, and so methods involving the addition of a filler having a high thermal conductivity are generally carried out.

Examples of such thermally conductive silicone rubbers that have hitherto been used include those disclosed in JP-B S63-46785 (Patent Document 1), JP No. 2886923 (Patent Document 2), JP-B H06-55891 (Patent Document 3), JP-A H10-39666 (Patent Document 4), and JP-A 2000-089600 (Patent Document 5). These are obtained by compounding thermally conductive fillers such as silica, alumina, magnesium oxide, silicon carbide or silicon nitride in hitherto used silicone rubbers. However, a large amount of filler must be compounded in order to increase the thermal conductivity, which has had a number of deleterious effects, such as worsening the rubber compression set essential for a rubber roller, decreasing the heat resistance, increasing the roll hardness due to the excess loading of filler, and making molding difficult to carry out.

To address this problem, an attempt was made to dramatically increase the thermal conductivity and compression set in fixing roll and fixing belt applications by using silicon metal powder (Patent Document 6: JP No. 4900584). Although it was thus possible to obtain a good thermal conductivity, this was designed for fixing rolls and fixing belts, and no mention is made in this publication of rubber development members such as development rolls and development belts. Nor is any description whatsoever given therein of the electrical conductivity properties that are essential for ensuring excellent image properties in rubber development members such as development rolls and development belts.

As for thermally conductive silicone rubber materials to which carbon black has been added for conferring electrically conductivity, in JP No. 4930729 (Patent Document 7), which describes the addition of carbon black and iron oxide (red iron oxide), the object is to eliminate the uneven coloration (brown) of silicon metal-containing materials by mixing in red iron oxide (red color) and carbon black (black color). No mention is made there of electrical conductivity, nor is any description given whatsoever of rubber development members such as development rolls and development belts.

### SUMMARY OF THE INVENTION

### Problems to be Solved by the Invention

The present invention has been done in view of the above circumstances. It is therefore an object of the present invention to provide a silicone rubber composition for a silicone rubber development member characterized by excellent image properties and high thermal conductivity, and to provide a thermally conductive silicone rubber development member (roll, belt, etc.) having a silicone rubber layer obtained by curing such a composition.

### Means for Solving the Problems

The inventors have conducted extensive investigations in order to attain the above object, as a result of which they have discovered that a thermally conductive silicone rubber development member (roll, belt, etc.) having a silicone rubber layer obtained by curing a thermally conductive silicone rubber composition containing an organopolysiloxane matrix consisting of a silicone polymer crosslinked structure to which has been added a thermally conductive powder of a small particle size and which has been rendered electrically conductive by additionally compounding therein carbon black has an electrical conductivity suitable for good image properties and an excellent thermal conductivity, and moreover has an excellent surface smoothness, enabling it to be effectively used as a rubber development member in high-speed, high-volume copiers and printers.

Accordingly, the invention provides the following silicone rubber composition for a thermally conductive silicone rubber development member, and the following thermally conductive silicone rubber development member such as a silicone development roll or silicone development belt having a silicone rubber layer obtained by curing such a composition.

[1] A silicone rubber composition for a thermally conductive silicone rubber development member which includes:

(A) 100 parts by weight of an organopolysiloxane containing in the molecule at least two alkenyl groups which bond with silicon atoms,

(B) from 40 to 400 parts by weight of a thermally conductive powder having an average primary particle size of not more than 30 μm and a thermal conductivity of at least 10 W/m·K,

(C) from 1 to 50 parts by weight of carbon black, and

(D) a curing agent in an amount capable of curing component (A),

the composition providing a cured silicone rubber having a thermal conductivity of at least 0.28 W/m·K.

[2] The silicone rubber composition of [1], wherein the thermally conductive powder of component (B) is silicon metal powder.
[3] The silicone rubber composition of [1] or [2], wherein the curing agent (D) is an addition reaction curing agent that is a combination of an organohydrogenpolysiloxane and an addition reaction catalyst.
[4] The silicone rubber composition of [1] or [2], wherein the curing agent (D) is an organic peroxide curing agent.
[5] A thermally conductive silicone development roll having, as at least one layer on an outer peripheral surface of a core bar, a silicone rubber layer that is a cured product of the silicone rubber composition for a thermally conductive silicone rubber development member according to any of [1] to [4].
[6] The thermally conductive silicone development roll of [5], further having, formed on an outer peripheral surface of the silicone rubber layer: a urethane resin layer, a silicone-modified urethane resin layer or a silane coupling coat.
[7] A thermally conductive silicone development belt having, as at least one layer on an outer peripheral surface of a belt base, a silicone rubber layer that is a cured product of the silicone rubber composition for a thermally conductive silicone rubber development member according to any of [1] to [4].
[8] The thermally conductive silicone development belt of [7], further having, formed on an outer peripheral surface of the silicone rubber layer: a urethane resin layer, a silicone-modified urethane resin layer or a silane coupling coat.

### Advantageous Effects of the Invention

The silicone rubber composition for a thermally conductive silicone rubber development member of the invention makes it possible to provide a thermally conductive silicone rubber development member, such as a silicone development roll or a silicone development belt, which has excellent image properties (electrical conductivity in specific regions) and which, by effectively diffusing heat generated on the rubber development member (roll, belt, etc.) during high-speed printing, lowers the surface temperature of the rubber development member, thus preventing melting of the toner and reducing toner damage.

### EMBODIMENT FOR CARRYING OUT THE INVENTION

The inventive silicone rubber composition for a thermally conductive silicone rubber development member includes:
(A) an organopolysiloxane containing in the molecule at least two alkenyl groups which bond with silicon atoms,
(B) a thermally conductive powder having an average primary particle size of not more than 30 μm and a thermal conductivity of at least 10 W/m·K,
(C) carbon black, and
(D) a curing agent capable of curing component (A).

Component (A), the base polymer of the silicone rubber composition for a thermally conductive silicone rubber development member, is an organopolysiloxane which has in the molecule at least two silicon atom-bonded alkenyl groups and is preferably in a liquid state or a crude rubber state (i.e., a high-viscosity, non-liquid state that lacks self-flowability) at room temperature (23° C.). Use may be made of a compound of the average compositional structure (1) below.

R¹ₐSiO_{(4-a)/2} (1)

(wherein R¹ is identical or different and an unsubstituted or substituted monovalent hydrocarbon group of 1 to 10 carbon atoms, and preferably 1 to 8 carbon atoms; and “a” is a positive number in the range of 1.5 to 2.8, and preferably 1.8 to 2.5).

Illustrative examples of the unsubstituted or substituted monovalent hydrocarbon groups bonded to silicon atoms that are represented here by R¹ include alkyl groups such as methyl, ethyl, propyl, isopropyl, butyl, isobutyl, tert-butyl, pentyl, neopentyl, hexyl, cyclohexyl, octyl, nonyl and decyl groups; aryl groups such as phenyl, tolyl, xylyl and naphthyl groups; aralkyl groups such as benzyl, phenylethyl and phenylpropyl groups; alkenyl groups such as vinyl, allyl, propenyl, isopropenyl, butenyl, hexenyl, cyclohexenyl and octenyl groups; and any of these groups in which some or all of the hydrogen atoms are substituted with halogen atoms (e.g., fluorine, bromine, chlorine) or cyano groups, examples of the latter being chloromethyl, chloropropyl, bromoethyl, trifluoropropyl and cyanoethyl groups. It is preferable for at least 90 mol % of all R¹ groups, and especially all R¹ groups exclusive of alkenyl groups, to be methyl groups.

At least two of the R¹ groups must be alkenyl groups (preferably ones having 2 to 8 carbon atoms, more preferably ones having 2 to 6 carbon atoms, and most preferably vinyl groups). The content of alkenyl groups is preferably from 1.0×10⁶ to 5.0×10³ mol/g, and more preferably from 5.0×10⁶ to 1.0×10³ mol/g, of the organopolysiloxane. When the amount of alkenyl groups is less than 1.0×10⁶ mol/g, sufficient crosslinking may not occur and a gel state may arise. On the other hand, at more than 5.0×10³ mol/g, the crosslink density becomes too high, as a result of which the rubber may be brittle. The alkenyl groups may be bonded to silicon atoms on the ends of the molecular chain, may be bonded to silicon atoms located somewhere along the molecular chain (that is, non-terminal silicon atoms), or may be bonded to both.

The molecular weight is such that the organopolysiloxane is in the state of a liquid or crude rubber at room temperature, with the degree of polymerization being preferably in the range of 50 to 50,000, and more preferably in the range of 80 to 20,000. This degree of polymerization is the average degree of polymerization measured as the polystyrene-equivalent weight average obtained by gel permeation chromatographic (GPC) analysis in which toluene, etc. typically serves as the developing solvent (the same applies below).

The structure of this organopolysiloxane is basically a linear structure in which the backbone is made up of recurring diorganosiloxane units (R¹₂SiO_{2/2}), such as dimethylsiloxane units, diphenylsiloxane units, methylphenylsiloxane units, methyltrifluoropropylsiloxane units or vinylmethylsiloxane units, and both ends of the molecular chain are capped with triorganosiloxy groups (R¹₃SiO_{1/2}), such as trimethylsiloxy, vinyldimethylsiloxy, divinylmethylsiloxy, trivinylsiloxy, vinyldiphenylsiloxy, vinylmethylphenylsiloxy, phenyldimethylsiloxy or diphenylmethylsiloxy groups, although the structure may be partially composed of branched structures, cyclic structures and the like.

Component (B) is a thermally conductive powder for imparting thermal conductivity to the silicone rubber composition of the invention. In the silicone rubber composition of the invention, a specific thermally conductive powder (B) is compounded with the organopolysiloxane (A).

The thermally conductive powder used in this invention has a thermal conductivity of at least 10 W/m·K, preferably at least 20 W/m·K, and more preferably at least 40 W/m·K. When the thermal conductivity of the thermally conductive powder is less than 10 W/m·K, a large amount of thermally conductive powder must be included in the silicone rubber composition, which is undesirable because this causes, in the cured silicone rubber, a decrease in the modulus of elasticity and a rise in hardness.

Illustrative examples of the thermally conductive powder include thermally conductive inorganic powders such as silicon metal powder, alumina, aluminum, silicon carbide, silicon nitride, magnesium oxide, magnesium carbonate, zinc oxide, aluminum nitride, graphite and fibrous graphite.

Of these, silicon metal powder can be most preferably used in this invention. Silicon metal has a good thermal conductivity, in addition to which it has a low Mohs hardness. Moreover, because silicon metal readily shatters when struck and has a low ductility, one property of the metal powder itself is that, even when subjected to high shear, it does not easily agglomerate. Hence, it is easily reduced to fine particles by grinding, and has properties that give it excellent dispersibility in organopolysiloxane. Therefore, in cases where a rubber development member such as a development roll in which silicon metal powder has been compounded is polished, the polishability is good, enabling a rubber development member of excellent surface smoothness to be obtained.

The thermally conductive powder used in this invention has an average primary particle size of not more than 30 μm. Use is generally made of a powder having an average primary particle size of not more than 15 μm, preferably from 0.1 to 12 μm, more preferably from 0.5 to 10 μm, and especially from 2 to 8 μm. Particles having an average primary particle size of less than 0.1 μm are difficult to produce, in addition to which dispersibility in silicone polymers (e.g., the alkenyl group-containing organopolysiloxane of component (A) serving as the base polymer) is poor, the primary particles do not readily disperse, and compounding a large amount of such a powder is difficult. On the other hand, at an average primary particle size greater than 30 μm, not only is the mechanical strength of the cured rubber diminished, when the rubber is used in a rubber development member such as a development roll or development belt, the surface becomes uneven, giving rise to performance-related problems, such as the image properties and toner transfer properties. Given that the primary particle size in mainstream copier and printer toners (colored fine particles) today is generally from about 5 μm to about 12 μm, and especially from about 5 μm to about 8 μm, it is desirable for rubber development members such as development rolls and development belts to have a surface roughness which is as low (smooth) as possible. A surface roughness of at most 10 μm or less, preferably 8 μm or less, more preferably 4 μm or less, and even more preferably 2 μm or less, is desired.

The purpose of the thermally conductive powder used in the invention is to impart thermal conductivity. However, as a result of such addition, depending on the particle size of the thermally conductive powder itself, unevenness sometimes arises on the surface of the rubber development member such as a development roll or development belt after it has been polished.

In cases where the average primary particle size of the thermally conductive powder is larger than the average primary particle size of the toner, etc., when organopolysiloxane matrix consisting of a silicone polymer crosslinked structure has been removed by polishing or the like during shaping of the roll, the thermally conductive powder emerges on the surface and the unevenness becomes larger than the average primary particle size of the toner, thus hindering the formation of a uniform toner layer thickness. Therefore, although this depends also on the particle size of the toner to be used in the copier or printer employed, it is generally desirable for the average primary particle size of the thermally conductive powder to be the same as or smaller than the average primary particle size of the toner, and especially desirable for it be smaller.

The thermally conductive powder has a hardness, expressed in terms of Mohs hardness, which is preferably at least 2 and not more than 10, and more preferably at least 3 and not more than 6.5. By using a thermally conductive powder of this suitable hardness, even if a little thermally conductive powder of a large particle size is present in the material, this is removed by polishing, forming a polished surface of the same height as the surrounding rubber material, thereby enabling the roll surface roughness to be reduced. When the thermally conductive powder is too hard, it remains on the roll surface as raised protrusions or as recessed areas such as craters. Toner is unable to adhere to raised areas and collects in recessed areas, making it difficult to achieve a uniform layer thickness. In addition, the thermally conductive powder that has formed protrusions on the roll surface abrades and scratches the OPC drum and other rolls that come into contact with this roll. Furthermore, in cases where thermally conductive powder having a high Mohs hardness is used, coarse particle components of the thermally conductive powder catch on the roll surface, sometimes forming scratches in the circumferential direction during polishing or long-term wear.

On the other hand, when the thermally conductive powder is too soft, the thermally conductive powder itself is removed in a somewhat larger amount than the surroundings, often forming gradual depressions, which likewise makes a uniform layer thickness difficult to achieve.

In this invention, the average primary particle size may be determined as the cumulative weight-average value D50 (or median diameter) using a particle size analyzer based on laser diffraction technology, etc.

The thermally conductive powder serving as component (B) may be one that has been surface-treated with a surface treating agent, examples of which include silane coupling agents or partial hydrolyzates thereof, alkylalkoxysilanes or partial hydrolyzates thereof, organic silazanes, titanate coupling agents, organopolysiloxane oils and hydrolyzable functional group-containing organopolysiloxanes, in order to enhance the thermal stability of the silicone rubber composition and facilitate addition of the thermally conductive powder. Such treatment may be carried out beforehand on the thermally conductive powder itself, or surface treatment may be carried out under applied heat when components (A) and (B) are mixed together.

The thermally conductive powder serving as component (B) is included in an amount, per 100 parts by weight of component (A), of from 40 to 400 parts by weight, and preferably from 50 to 300 parts by weight. At less than 40 parts by weight, the desired high thermal conductivity is not obtained. On the other hand, including more than 400 parts by weight invites a decline in rubber elasticity and a dramatic decrease in properties such as rubber strength.

It is desirable for the thermally conductive silicone rubber development member of the invention to have a low hardness, with a good rubber elasticity and good compression set in particular being essential. It is thus desirable to add the thermally conductive powder in a minimum amount which is of a degree that does not adversely affect these properties.

Component (C) of the invention is carbon black. For a rubber development member such as a development roll or development belt, this is necessary to achieve a conductivity (or volume resistivity) in specific regions that is suitable for obtaining clear image properties. Various types of black-colored carbon black produced by known processes may be used. Although the electrical conductivity of carbon black varies with the method of production, use may be made of any carbon black which, when used together and mixed with the alkenyl group-containing organopolysiloxane serving as component (A) and the thermally conductive powder serving as component (B), achieves the desired electrical conductivity.

The carbon black is not particularly limited. For example, any of those mentioned below may be used singly, or two or more may be used in combination. Exemplary carbon blacks include acetylene blacks, conductive furnace blacks (CF), superconductive furnace blacks (SCF), extra-conductive furnace blacks (XCF), conductive channel blacks (CC), furnace blacks and channel blacks that have been heat-treated at an elevated temperature of about 1,500 to 3,000° C., carbon nanoparticles and carbon nanofibers. Examples of acetylene blacks include Denka Black (from Denki Kagaku Kogyo KK) and Shawinigan Acetylene Black (Shawinigan Chemical Co.), examples of conductive furnace blacks include Continex CF (Continental Carbon Co.) and Vulcan C (Cabot Corporation), examples of superconductive furnace blacks include Continex SCF (Continental Carbon Co.) and Vulcan SC (Cabot Corporation), examples of extra-conductive furnace blacks include Asahi HS-500 (Asahi Carbon Co., Ltd.) and Vulcan XC-72 (Cabot Corporation), and an example of a conductive channel black is Corax L (Degussa). Use can also be made of Ketjenblack EC-350 and Ketjenblack EC-600JD (Ketjen Black International), which are types of furnace black, and ENSACO 260G and ENSACO 250G (Timcal Graphite & Carbon) produced by the “MMM Process,” which is an oil combustion process that does not include a water quenching step in the oil combustion reaction shutdown step. It is desirable for carbon black produced by the furnace method to have a content of impurities, particularly sulfur and sulfur compounds, such that the elemental concentration of sulfur is not more than 6,000 ppm, and preferably not more than 3,000 ppm. Acetylene black has a low impurities content, and thus is especially preferred for use in this invention.

The carbon black serving as component (C) is included in an amount, per 100 parts by weight of component (A), of from 1 to 50 parts by weight, and preferably from 2 to 20 parts by weight. At less than 1 part by weight, the desired electrical conductivity is not obtained, whereas at more than 50 parts by weight, physical mixing is difficult and the mechanical strength decreases, as a result of which the intended rubber elasticity is not obtained and the compression set worsens, or the rubber hardness becomes too hard.

The amount of carbon black included as component (C) is more preferably such as to set the volume resistivity of the inventive silicone rubber composition in its cured form (silicone rubber) to generally not more than 1 kΩ·m, and especially from about 1.0 to about 100 Ω·m.

A known curing agent that works by way of an addition reaction or a known organic peroxide curing agent may be used as the curing agent serving as component (D) of the invention.

Here, the addition-type curing agent is a combination of (D-1) an organohydrogenpolysiloxane and (D-2) an addition reaction catalyst.

The organohydrogenpolysiloxane (D-1) acts as a crosslinking agent which cures the composition by means of a hydrosilylation addition reaction with the alkenyl group-containing organopolysiloxane of component (A). The use of a compound represented by the following average compositional formula (2)

R²_{b}H_{c}SiO_{(4-b-c)/2} (2)

(wherein R² is an unsubstituted or substituted monovalent hydrocarbon group of 1 to 10 carbon atoms, “b” is a positive number from 0.7 to 2.1, and especially from 0.8 to 2.0, “c” is a positive number from 0.001 to 1.0, and the sum “b+c” is a positive number from 0.8 to 3.0, and especially from 1.0 to 2.5) and having in the molecule at least 2, preferably 3 or more (typically from 3 to 200), more preferably from 3 to 100, and even more preferably from 3 to 50, silicon atom-bonded hydrogen atoms (SiH groups) is preferred.

The silicon atom-bonded hydrogen atoms may be bonded to silicon atoms at the ends of the molecular chain, may be bonded to silicon atoms located somewhere along the molecular chain (that is, non-terminal silicon atoms), or may be bonded to both.

Here, R² is exemplified by the same groups as R¹ in formula (1), and is preferably a group which does not have aliphatic unsaturated bonds such as alkenyl groups.

Examples of such organohydrogenpolysiloxanes include tris(dimethylhydrogensiloxy)methylsilane, tris(dimethylhydrogensiloxy)phenylsilane, 1,1,3,3-tetramethyldisiloxane, 1,3,5,7-tetramethylcyclotetrasiloxane, methylhydrogencyclopolysiloxane, methylhydrogensiloxane/dimethylsiloxane cyclic copolymers, methylhydrogenpolysiloxane capped at both ends with trimethylsiloxy groups, dimethylsiloxane/methylhydrogensiloxane copolymers capped at both ends with trimethylsiloxy groups, dimethylpolysiloxane capped at both ends with dimethylhydrogensiloxy groups, methylhydrogenpolysiloxane capped at both ends with dimethylhydrogensiloxy groups, dimethylsiloxane/methylhydrogensiloxane copolymers capped at both ends with dimethylhydrogensiloxy groups, methylhydrogensiloxane/diphenylsiloxane copolymers capped at both ends with trimethylsiloxy groups, methylhydrogensiloxane/diphenylsiloxane/dimethylsiloxane copolymers capped at both ends with trimethylsiloxy groups, copolymers consisting of (CH₃)₂HSiO_{1/2} units and SiO_{4/2} units, copolymers consisting of (CH₃)₂HSiO_{1/2} units and SiO_{4/2} units, as well as any of these compounds in which some or all of the methyl groups are substituted with other alkyl groups such as ethyl or propyl groups, aryl groups such as phenyl groups, or halogen-substituted alkyl groups such as 3,3,3-trifluoropropyl groups.

This organohydrogenpolysiloxane has a molecular structure which may be linear, cyclic, branched or a three-dimensional network structure. Use may be made of an organohydrogenpolysiloxane in which the number of silicon atoms in the molecule (or the degree of polymerization) is from 2 to 1,000, preferably from 3 to 500, more preferably from 3 to 300, and most preferably from about 4 to about 150.

The organohydrogenpolysiloxane is included in an amount, per 100 parts by weight of the organopolysiloxane serving as component (A), of preferably from 0.1 to 50 parts by weight, more preferably from 0.1 to 30 parts by weight, even more preferably from 0.3 to 30 parts by weight, and still more preferably from 0.3 to 20 parts by weight.

Also, the organohydrogenpolysiloxane may be included in an amount such that the molar ratio of hydrogen atoms bonded to silicon atoms (i.e., SiH groups) in component (D-1) with respect to alkenyl groups bonded to silicon atoms in component (A) is from 0.5 to 5 mol/mol, preferably form 0.8 to 4 mol/mol, and more preferably from 1 to 3 mol/mol.

The addition reaction catalyst (D-2) is a catalyst for promoting a hydrosilylation addition reaction between alkenyl groups bonded to silicon atoms in component (A) and SiH groups in the organohydrogenpolysiloxane (D-1). This addition reaction catalyst is exemplified by platinum group metal catalysts, including platinum catalysts such as platinum black, platinic chloride, chloroplatinic acid, the reaction products of chloroplatinic acid with monohydric alcohols, chloroplatinic acid-olefin complexes, and platinum bisacetoacetate; palladium catalysts; and rhodium catalysts. The amount of addition reaction catalyst included may be set to the catalytic amount. Generally, it is preferable to include from about 0.5 to about 1,000 ppm, and especially from about 1 to about 500 ppm, of platinum group metal with respect to the total weight of components (A) and (D-1).

The organic peroxide curing agent (D-3) may be one that is used as a catalyst to promote crosslinking reactions on component (A) in the organic peroxide-curable organopolysiloxane composition. Any such curing agent that is known may be used. Illustrative examples include, but are not particularly limited to, benzoyl peroxide, 2,4-dichlorobenzoyl peroxide, p-methylbenzoyl peroxide, o-methylbenzoyl peroxide, 2,4-dicumyl peroxide, 2,5-dimethylbis(2,5-t-butylperoxy)hexane, di-t-butyl peroxide, t-butyl perbenzoate and 1,1-bis(t-butylperoxycarboxy)hexane.

The organic peroxide curing agent is added in the catalytic amount, and should be selected as appropriate for the curing rate. The amount of addition may generally be set in the range of 0.1 to 10 parts by weight, and preferably 0.2 to 2 parts by weight.

In this invention, the above-described addition crosslinking and organic peroxide crosslinking may also be used together. Addition crosslinking is recommended for curing liquid silicone rubber compositions.

In addition to the above ingredients, where necessary, the silicone rubber composition of the invention may optionally have compounded therein, within ranges that do not detract from the advantageous effects of the invention: reinforcing and semi-reinforcing fillers, including finely divided silicas such as fumed silica, precipitated silica, fused silica, pyrogenic silica, spherical silica obtained by the sol-gel process, crystalline silica (quartz powder) and diatomaceous earth (of these silicas, fused silica and crystalline silica in particular sometimes act also as other thermally conductive materials), calcium carbonate, clay, diatomaceous earth and titanium dioxide; silicone resins serving as reinforcements; hydrosilylation reaction regulators such as nitrogen-containing compounds and acetylene compounds, phosphorus compounds, nitrile compounds, carboxylates, tin compounds, mercury compounds and sulfur compounds; heat stabilizers such as cerium oxide; internal mold release agents such as dimethyl silicone oils; tackifiers; and thixotropic agents. In addition, heat-resistance enhancing agents such as cerium oxide, iron oxide and iron octanoate, various carbon-functional silanes for enhancing adhesion and molding processability, and nitrogen compounds or halogen compounds for imparting flame retardance may be added and mixed in.

The method employed for mixing the powder components, i.e., the thermally conductive powder (B) and the carbon black (C), used in the invention into the base polymer (component (A)) may be one where an apparatus such as planetary mixer or a kneader is used at a normal temperature (generally, 25° C.±10° C.) to mix together components (A), (B) and (C) at the same time. However, because component (C) is generally finely divided, with a particle size of 1 μm or less, and does not readily disperse, it is also possible to first mix together components (A) and (C), then carry out high dispersion using a paint mixer (3-roll mill) or the like, and subsequently mix the dispersion together with component (B) and the curing agent (component (D)).

Heat treatment during preparation of the composition is optional. In cases where heat treatment is carried out, any of various methods may be used, such as, for example, the method of preparing a base compound by first mixing together components (A), (B) and (C), a finely divided silica filler, a silanol group-containing silane and the like (e.g., by mixing together the respective ingredients all at once, or by pre-mixing components (A) and (C), then mixing in the remaining ingredients), then using equipment such as a planetary mixer or kneader and a dryer to mix and heat-treat the compound at an elevated temperature of 50 to 200° C. for a period of from several minutes to several hours; the method of first heat-treating components (B) and (C) as powders at 50 to 200° C. for a period of from several minutes to several hours so as to uniformly form a surface oxide film, then successively adding and mixing in component (A) and the finely divided silica filler; and the method of first mixing together components (B) and (C), an alkylalkoxysilane and an organic silazane, etc. into a powder, carrying out heat treatment at 50 to 200° C. for a period of from several minutes to several hours so as to surface-treat the powder, then adding and mixing in component (A) and the finely divided silica filler. Alternatively, where necessary, preparation may be carried out by adding various additives, flame retardants, heat stabilizers and the like, with or without the heat treatment of such additives and at any timing for such heat treatment, then carrying out mixture and heat treatment with a mixing apparatus in the same way as above.

The resulting silicone rubber composition for a thermally conductive silicone rubber development member can be molded for the required application by any of various molding methods commonly used for molding silicone, such as casting, liquid injection molding (LIM), and pressure molding. The molding conditions, although not particularly limited, are preferably in the range of 70 to 400° C. for a period of from several seconds to one hour. In cases where secondary vulcanization is carried out after molding, such secondary vulcanization is preferably carried out in the range of 150 to 250° C. for a period of from 1 to 30 hours.

It is preferable for the cured form of the inventive silicone rubber composition (silicone rubber) to have a volume resistivity which is generally not more than 1 kΩ·m, and especially from about 1.0 to about 100 Ω·m. At less than 1.0 Ω·m, the content of the carbon black serving as component (C) which confers electrical conductivity is too high, as a result of which a good roll durability may not be obtained. On the other hand, at a volume resistivity larger than 1 kΩ·m, the volume resistance is unstable, which may make the rubber development member unable to obtain clear images.

A higher thermal conductivity is not necessarily better in the rubber development member; there exists a thermal conductivity range that is best for use. In this invention, based on the heat conducting properties of a rubber development member suitable for use, it is critical for the cured form of the inventive silicone rubber composition (silicone rubber) to have a thermal conductivity which is at least 0.28 W/m·K, with the thermal conductivity being preferably from 0.30 to 1.2 W/m·K, and more preferably from 0.3 to 0.5 W/m·K. When the thermal conductivity of the silicone rubber is lower than 0.28 W/m·K, the frictional heat generated on the rubber development member is unable to efficiently diffuse, as a result of which the toner melts, incurring damage and ultimately deteriorating.

Thermally conductive silicone rubber development members having a silicone rubber layer obtained by curing the inventive silicone rubber composition for a thermally conductive silicone rubber development member are used primarily in the shape of a roll, such as a silicone development roll.

In the development roll, a thermally conductive cured layer of the silicone rubber composition (silicone rubber layer) is formed on an outer peripheral surface of a core bar. In this case, the material, dimensions and the like of the core bar may be suitably selected according to the type of roll, although the core bar is typically made of, for example, aluminum, iron or stainless steel (SUS). It is preferable for the surfaces of these core bars to be treated with a primer such as a silane coupling agent or a silicone adhesive so as to further strengthen adhesion with the silicone rubber layer.

The methods for molding and curing the silicone rubber composition may be suitably selected. That is, molding may be carried out by a method such as casting, transfer molding, injection molding or coating, and curing is achieved by heating. The silicone rubber layer obtained by curing the silicone rubber composition may be a single layer formed alone, or a plurality of two or more layers, each having different amounts of the thermally conductive powder serving as component (B), may be arranged in combination as successive layers. The total thickness of this silicone rubber layer is preferably from 50 μm to 20 mm, and more preferably from 0.2 to 6 mm. When it is too thin, a sufficient rubber elasticity may not be obtained. On the other, when it is too thick, the heat transfer properties between the core bar and the rubber roll surface may be compromised.

A urethane resin layer, silicone-modified urethane resin layer or silane coupling coat may additionally be formed on the outer periphery of the silicone rubber layer. Here, the urethane resin is exemplified by resins obtained by reacting a polyether polyol or a polyester polyol with an aromatic polyisocyanate or an aliphatic polyisocyanate. The silicone-modified urethane resins can be obtained by curing a polyol or polyisocyanate in which a portion of the main chain or side chains has been modified with silicone units.

The silane coupling coat is obtained by suitably selecting a silane coupling agent which has at least one hydrolyzable group and which, by coating, is capable of forming a coat having a thickness of from 0.1 μm to several microns. The silane coupling agent may suitably have functional groups such as hydrocarbon groups, hydrocarbon unsaturated groups, acrylic groups, epoxy groups and amino groups.

The resin layer (urethane resin layer, silicone-modified urethane resin layer, or silane coupling coat) may be used singly or two or more may be used in admixture. These resin layers may be electrically conductive or electrically non-conductive, although it is desirable for them to be electrically conductive when controlling the electrostatic properties of the toner. To render the resin layer electrically conductive, use may be made of an electrically conductive material, examples of which include carbon black, ionic liquids such as pyridinium-based ionic liquids and amine-based ionic liquids, and conductive inorganic mixed oxides such as conductive zinc white or conductive titanium. These conductive materials may be used singly or two or more may be used in combination. Alternatively, spherical/non-spherical particles having a particle size of about 0.1 to 5 μm may be added to the coat. Examples of spherical/non-spherical particles include urethane powder, fluoroplastics such as PTFE, acrylic resins and spherical silica.

The thickness of the urethane resin layer, silicone-modified urethane resin layer or silane coupling coat layer is preferably form 0.1 to 100 μm, and more preferably from 0.5 to 40 μm. If the layer is too thin, tearing, creasing or peeling may arise when external stresses act on the roll. On the other hand, if the layer is too thick, the rubber elasticity of the roll surface may be lost or appearance defects such as cracks and breaks may arise.

Thermally conductive silicone rubber development members having a silicone rubber layer obtained by curing the inventive silicone rubber composition for thermally conductive silicone rubber development members can also be used in the form of a belt, such as a silicone development belt. Exemplary rubber development members include silicone development belts which are obtained by forming a thermally conductive cured layer of the silicone rubber composition (silicone rubber layer) on the surface (outer peripheral surface) of a SUS or other metal thin-film belt base or an organic resin belt base made of a polyimide resin and/or a polyamide resin, and which have a belt inside diameter, centered on a core bar, that is at least 5% larger than the core bar diameter. The total thickness of the silicone rubber layer is preferably from 50 μm to 5 mm, and more preferably from 100 μm to 1 mm. When the layer is too thin, tearing, rubber elasticity may not be obtained. On the other hand, when the layer is too thick, the heat transfer properties between the belt surface and the base may be lost.

A resin layer such as a urethane resin layer, a silicone-modified urethane resin layer or a silane coupling coat may be additionally formed on the periphery of the silicone rubber layer of the development belt. Layers similar to those in the development roll described above may be used for this purpose. These resin layers have a thickness of preferably from 0.1 to 100 μm, and more preferably from 0.5 to 40 μm. When the layer is too thin, tearing, creasing or peeling may arise when external stresses act on the belt. On the other hand, when the layer is too thick, the rubber elasticity of the belt surface may be lost or appearance defects such as cracks and breaks may arise.

### EXAMPLES

Reference Examples, Working Examples and Comparative Examples are given below by way of illustration and not by way of limitation. The degree of polymerization indicates the polystyrene-equivalent weight-average degree of polymerization obtained from GPC analysis using toluene as the developing solvent.

### Example 1

A planetary mixer was charged with 60 parts by weight of a linear dimethylpolysiloxane capped at both ends of the molecular chain with dimethylvinylsiloxy groups (degree of polymerization, 500), 1.0 part by weight of hydrophobized fumed silica having a BET specific surface area of 110 m²/g (R-972, from Nippon Aerosil Co., Ltd.), 4.0 parts by weight of Denka Black powder (Denki Kagaku Kogyo KK; average primary particle size, 40 nm), which is an acetylene black-type of carbon black, and 70 parts by weight of ground silicon metal powder A (average primary particle size, 5 μm), and stirring was carried out a room temperature (23° C.) for 2 hours. The mixture was applied to a three-roll mill and dispersion was carried out. The mixture was then returned to the planetary mixer, where 40 parts by weight of a linear dimethylpolysiloxane capped at both ends of the molecular chain with trimethylsiloxy groups and having methylvinylsiloxane units on the main chain and pendant vinyl groups (degree of polymerization, 300; vinyl group content, 0.000075 mol/g), 1.0 part by weight of a methylhydrogenpolysiloxane having SiH groups at both ends and on side chains (degree of polymerization, 17; SiH group content, 0.0038 mol/g; a dimethylsiloxane/methylhydrogensiloxane copolymer capped at both ends of the molecular chain with dimethylhydrogensiloxy groups), 0.05 part by weight of ethynylcyclohexanol and 0.05 part by weight of tetramethyltetravinylcyclotetrasiloxane as reaction regulators, and 0.1 part by weight of platinum catalyst (Pt concentration, 1 wt %) were added and stirring was continued for 15 minutes, thereby preparing an addition-curable, electrically conductive, liquid silicone rubber composition.

The resulting addition-curable, electrically conductive, liquid silicone rubber composition was liquid injection-molded over a 10 mm diameter core bar in a casting mold having a mold inside diameter of 16 mm, and cured by 20 minutes of heating at 120° C. This molding was polished, thereby forming a development roll 1 having an outside diameter of 14 mm, a rubber layer thickness of 2 mm and a rubber length of 220 mm.

The addition-curable, electrically conductive, liquid silicone rubber composition and development roll 1 thus obtained were subjected to various evaluations by the measurement methods described below. The results are shown in Table 1.

### (Hardness and Rubber Density)

The hardness and rubber density were each measured in accordance with JIS K 6249 using a 2 mm thick silicone rubber sheet obtained by press-curing the silicone rubber composition under an applied pressure of 35 kgf/cm² at 120° C. for 10 minutes using a pressing plate and a retaining mold, then carrying out a 4-hour post-cure (secondary curing) at 200° C.

### (Compression Set)

Compression set after 22 hours at 180° C. and 25% compression was measured in accordance with JIS K 6249 using a cylindrical silicone rubber test specimen having a diameter of 29 mm and a thickness of 12.5 mm obtained by press-curing the silicone rubber composition under an applied pressure of 35 kgf/cm² at 120° C. for 10 minutes using a pressing plate and a retaining mold, then carrying out a 4-hour post-cure (secondary curing) at 200° C.

### (Volume Resistivity and Thermal Conductivity)

The volume resistivity was measured by the four-point probe method in accordance with JIS K 6249 using a 1 mm thick sheet obtained by press-curing the silicone rubber composition under an applied pressure of 35 kgf/cm² at 120° C. for 10 minutes using a pressing plate and a retaining mold, then carrying out a 4 hour post-cure (secondary curing) at 200° C. The thermal conductivity was measured with a thermal conductivity meter (QTM-3, from Kyoto Electronics Manufacturing Co., Ltd.) using a 12 mm thick sheet obtained by the same method as above.

### (Method of Measuring Roll Surface Roughness)

The ten-point average roughness Rz (μm) was measured in accordance with JIS B 0601-1984. A surface roughness meter equipped with a measuring probe having a 2 μm tip radius (available under the product name “590A” from Tokyo Seimitsu Co., Ltd.) was set to a development roll 1 and the roughness of the surface at no less than 3 points was measured along the circumferential direction or axial direction thereof. Measurement length, 2.4 mm; cutoff wavelength, 0.8 mm; cutoff type, gaussian. The arithmetic average of these roughness measurements was used.

### (Roll Heat Generation Test)

The fabricated development roll 1 was rolled at a speed of 60 rpm over thick filter paper while applying a load of 500 g at both ends, thereby generating frictional heat. The roll surface temperature after 5 minutes was measured with a contact-type thermometer. The testing environment was a 23° C. thermostatic chamber, and the filter paper used was No. 26 from Advantec Toyo Kaisha, Ltd.

### Example 2

Aside from using the following Example 1 curing agents: 1.0 part by weight of the methylhydrogenpolysiloxane having SiH groups at both ends and on side chains (a dimethylsiloxane/methylhydrogensiloxane copolymer capped at both ends of the molecular chain with dimethylhydrogensiloxy groups and having a degree of polymerization of 17 and a SiH group content of 0.0038 mol/g), 0.05 part by weight of ethynylcyclohexanol, 0.05 part by weight of tetramethyltetravinylcyclotetrasiloxane and, instead of 0.1 part by weight of platinum catalyst (Pt concentration, 1 wt %), 0.5 part by weight of 2,5-dimethylbis(2,5-t-butylperoxy)hexane as the curing agents and moreover changing the press-curing temperature to 165° C., an organic peroxide-curable, electrically conductive, liquid silicone rubber composition was prepared in the same way as in Example 1. The rubber was molded and data was obtained in the same way as in Example 1. The results are shown in Table 1.

### Example 3

Aside from using 100 parts by weight of silicon carbide powder C (average primary particle size, 11 μm) instead of 70 parts by weight of ground silicon metal powder A, an addition-curable, electrically conductive, liquid silicone rubber composition was prepared in the same way as in Example 1. The rubber was molded and data was obtained in the same way as in Example 1. The results are shown in Table 1.

### Example 4

Aside from using 200 parts by weight of spherical alumina D (average primary particle size, 10 μm) instead of 70 parts by weight of ground silicon metal powder A, an addition-curable, electrically conductive, liquid silicone rubber composition was prepared in the same way as in Example 1. The rubber was molded and data was obtained in the same way as in Example 1. The results are shown in Table 1.

### Example 5

Aside from setting the amount of ground silicon metal powder A to 50 parts by weight, an addition-curable, electrically conductive, liquid silicone rubber composition was prepared in the same way as in Example 1. The rubber was molded and data was obtained in the same way as in Example 1. The results are shown in Table 1.

### Example 6

Aside from setting the amount of ground silicon metal powder A to 90 parts by weight, an addition-curable, electrically conductive, liquid silicone rubber composition was prepared in the same way as in Example 1. The rubber was molded and data was obtained in the same way as in Example 1. The results are shown in Table 1.

### Example 7

Aside from setting the amount of ground silicon metal powder A to 160 parts by weight, an addition-curable, electrically conductive, liquid silicone rubber composition was prepared in the same way as in Example 1. The rubber was molded and data was obtained in the same way as in Example 1. The results are shown in Table 1.

### Comparative Example 1

Aside from using 90 parts of ground silicon metal powder B (average primary particle size, 40 μm) instead of 70 parts by weight of ground silicon metal powder A, an addition-curable, electrically conductive, liquid silicone rubber composition was prepared in the same way as in Example 1. The rubber was molded and data was obtained in the same way as in Example 1. The results are shown in Table 2.

### Comparative Example 2

Aside from using 200 parts of spherical alumina E (average primary particle size, 40 μm) instead of 70 parts by weight of ground silicon metal powder A, an addition-curable, electrically conductive, liquid silicone rubber composition was prepared in the same way as in Example 1. The rubber was molded and data was obtained in the same way as in Example 1. The results are shown in Table 2.

### Comparative Example 3

Aside from using 40 parts of diatomaceous earth powder F (average primary particle size, 8 μm) instead of 70 parts by weight of ground silicon metal powder A, an addition-curable, electrically conductive, liquid silicone rubber composition was prepared in the same way as in Example 1. The rubber was molded and data was obtained in the same way as in Example 1. The results are shown in Table 2.

### Comparative Example 4

Aside from using 80 parts of diatomaceous earth powder F (average primary particle size, 8 μm) instead of 70 parts by weight of ground silicon metal powder A, a silicone rubber composition was prepared in the same way as in Example 1. However, clumping of this silicone rubber composition arose prior to crosslinking, making sheet formation impossible. As a result, no data could be collected.

### Comparative Example 5

Aside from using 140 parts of crystalline silica G (average primary particle size, 5 μm) instead of 70 parts by weight of ground silicon metal powder A, an addition-curable, electrically conductive, liquid silicone rubber composition was prepared in the same way as in Example 1. The rubber was molded and data was obtained in the same way as in Example 1. The results are shown in Table 2.

### Comparative Example 6

Aside from not compounding ground silicon metal powder A, an addition-curable, electrically conductive, liquid silicone rubber composition was prepared in the same way as in Example 1. The rubber was molded and data was obtained in the same way as in Example 1. The results are shown in Table 2.

TABLE 1

| | Example | | | | | | |
|---|---|---|---|---|---|---|---|
| | 1 | 2 | 3 | 4 | 5 | 6 | 7 |
| Amount of Denka Black | 4 | 4 | 4 | 4 | 4 | 4 | 4 |
| (pbw) | | | | | | | |
| Type of thermally | A | A | C | D | A | A | A |
| conductive powder | | | | | | | |
| Amount of thermally | 70 | 70 | 100 | 200 | 50 | 90 | 160 |
| conductive powder (pbw) | | | | | | | |
| Type of crosslinking | addition | organic | addition | addition | addition | addition | addition |
| agent | crosslinker | peroxide | crosslinker | crosslinker | crosslinker | crosslinker | crosslinker |
| | | crosslinker | | | | | |
| Mohs hardness of | 5 | 5 | 13 | 12 | 5 | 5 | 5 |
| thermally conductive | | | | | | | |
| powder | | | | | | | |
| Average primary particle | 5 | 5 | 11 | 10 | 5 | 5 | 5 |
| size of thermally | | | | | | | |
| conductive powder (μm) | | | | | | | |
| Thermal conductivity of | 168 | 168 | 46 | 21 | 168 | 168 | 168 |
| thermally conductive | | | | | | | |
| powder (W/m · K) | | | | | | | |
| Hardness (Durometer A) | 32 | 33 | 33 | 23 | 28 | 35 | 50 |
| Rubber density (g/cm³) | 1.23 | 1.23 | 1.44 | 1.57 | 1.19 | 1.29 | 1.51 |
| Compression set (%), | 4 | 3 | 6 | 10 | 2 | 6 | 12 |
| 180° C./22 hr | | | | | | | |
| Volume resistivity | 30 | 32 | 98 | 105 | 26 | 82 | 120 |
| (Ω · m) | | | | | | | |
| Thermal conductivity | 0.4 | 0.4 | 0.5 | 0.5 | 0.3 | 0.5 | 1.0 |
| (W/m · K) | | | | | | | |
| Roll surface roughness | 0.8 | 0.8 | 3 | 4 | 0.6 | 0.8 | 0.7 |
| after polishing (μm) | | | | | | | |
| Roll surface temperature | 50 | 52 | 47 | 46 | 55 | 47 | 43 |
| in heat generation test | | | | | | | |
| (° C.) | | | | | | | |

TABLE 2

| | Comparative Example | | | | | |
|---|---|---|---|---|---|---|
| | 1 | 2 | 3 | 4 | 5 | 6 |
| Amount of Denka Black | 4 | 4 | 4 | 4 | 4 | 4 |
| (pbw) | | | | | | |
| Type of thermally | B | E | F | F | G | — |
| conductive powder | | | | | | |
| Amount of thermally | 90 | 200 | 40 | 80 | 140 | 0 |
| conductive powder (pbw) | | | | | | |
| Type of crosslinking | addition | addition | addition | addition | addition | addition |
| agent | crosslinker | crosslinker | crosslinker | crosslinker | crosslinker | crosslinker |
| Mohs hardness of | 5 | 12 | 6.5 | 6.5 | 7 | — |
| thermally conductive | | | | | | |
| powder | | | | | | |
| Average primary particle | 40 | 40 | 8 | 8 | 5 | — |
| size of thermally | | | | | | |
| conductive powder (μm) | | | | | | |
| Thermal conductivity of | 168 | 21 | 6 | 6 | 8 | — |
| thermally conductive | | | | | | |
| powder (W/m · K) | | | | | | |
| Hardness (Durometer A) | 32 | 20 | 60 | — | 80 | 20 |
| Rubber density (g/cm³) | 1.23 | 1.57 | 1.18 | — | 1.50 | 1.01 |
| Compression set (%), | 6 | 8 | 16 | — | 17 | 2 |
| 180° C./22 hr | | | | | | |
| Volume resistivity | 81 | 104 | 510 | — | 308 | 18 |
| (Ω · m) | | | | | | |
| Thermal conductivity | 0.5 | 0.5 | 0.25 | — | 0.5 | 0.2 |
| (W/m · K) | | | | | | |
| Roll surface roughness | 15 | 20 | 3 | — | 2.5 | 0.4 |
| after polishing (μm) | | | | | | |
| Roll surface temperature | 46 | 46 | 73 | — | 50 | 81 |
| in heat generation test | | | | | | |
| (° C.) | | | | | | |

The properties of the thermally conductive powders used in the Working Examples and the Comparative Examples are shown in Table 3 below.

TABLE 3

| | | Average | | |
|---|---|---|---|---|
| | | primary | | |
| Thermally | | particle | | Thermal |
| conductive | | size | Mohs | conductivity |
| powder | Type | (μm) | hardness | (W/m · K) |
| Silicon metal | silicon | 5 | 5 | 168 |
| powder A | metal powder | | | |
| Silicon metal | silicon | 40 | 5 | 168 |
| powder B | metal powder | | | |
| Silicon carbide | silicon carbide | 11 | 13 | 46 |
| powder C | | | | |
| Spherical | aluminum oxide | 10 | 12 | 21 |
| alumina D | | | | |
| Spherical | aluminum oxide | 40 | 12 | 21 |
| alumina E | | | | |
| Diatomaceous | diatomaceous | 8 | 6.5 | 6 |
| earth | earth | | | |
| powder F | | | | |
| Crystalline silica | crystalline | 5 | 7 | 8 |
| G | silica | | | |

As is apparent from the above results, development rolls that used the inventive silicone rubber composition for a thermally conductive silicone rubber development member (Working Examples) were characterized by having an excellent heat dissipating ability, high elasticity and low hardness, in addition to which the roll appearance was good.

1. A silicone rubber composition for a thermally conductive silicone rubber development member, comprising:
(A) 100 parts by weight of an organopolysiloxane containing in the molecule at least two alkenyl groups which bond with silicon atoms,
(B) from 40 to 400 parts by weight of a thermally conductive powder having an average primary particle size of not more than 30 μm and a thermal conductivity of at least 10 W/m·K,
(C) from 1 to 50 parts by weight of carbon black, and
(D) a curing agent in an amount capable of curing component (A),
said composition providing a cured silicone rubber having a thermal conductivity of at least 0.28 W/m·K.

2. The silicone rubber composition of claim 1, wherein the thermally conductive powder of component (B) is silicon metal powder.

3. The silicone rubber composition of claim 1 or 2, wherein the curing agent (D) is an addition reaction curing agent that is a combination of an organohydrogenpolysiloxane and an addition reaction catalyst.

4. The silicone rubber composition of claim 1 or 2, wherein the curing agent (D) is an organic peroxide curing agent.

5. A thermally conductive silicone development roll comprising, as at least one layer on an outer peripheral surface of a core bar, a silicone rubber layer that is a cured product of the silicone rubber composition for a thermally conductive silicone rubber development member according to claim 1.

6. The thermally conductive silicone development roll of claim 5, further comprising, formed on an outer peripheral surface of the silicone rubber layer: a urethane resin layer, a silicone-modified urethane resin layer or a silane coupling coat.

7. A thermally conductive silicone development belt comprising, as at least one layer on an outer peripheral surface of a belt base, a silicone rubber layer that is a cured product of the silicone rubber composition for a thermally conductive silicone rubber development member according to claim 1.

8. The thermally conductive silicone development belt of claim 7, further comprising, formed on an outer peripheral surface of the silicone rubber layer: a urethane resin layer, a silicone-modified urethane resin layer or a silane coupling coat.
